(19) United States
(12) Patent Application Publication
(10) Pub. No.: US 2026/0106706 A1
(43) Pub. Date: Apr. 16, 2026

(54) UL-RS PORT MAPPING FOR MULTI-TRP OPERATION

(71) Applicant: Telefonaktiebolaget LM Ericsson (publ), Stockholm (SE)

(72) Inventors: Andreas Nilsson, Göteborg (SE); Sven Jacobsson, Västra Frölunda (SE); Siva Muruganathan, Stittsville, Ontario (CA)

(21) Appl. No.: 19/116,125

(22) PCT Filed: Sep. 29, 2023
(86) PCT No.: PCT/IB2023/059786

§ 371 Date: Mar. 27, 2025

Related U.S. Application Data
(60) Provisional application No. 63/411,912, filed on Sep. 30, 2022.

(51) Int. Cl. H04L 5/00; H04B 7/06; H04L 27/26

(52) U.S. Cl. CPC H04L 5/0044; H04B 7/0626; H04L 27/2607

(57) ABSTRACT

Various embodiments described herein provide for a method and system to adapt uplink reference signals (UL-RS) resource configurations to handle Multiple Transmission Reception Point (Multi-TRP) operation for 5G advanced and/or 6G by adapting the cyclic shift separation between UL-RS ports belonging to the same User Equipment (UE) and/or adapting the cyclic shift separation between UL-RS ports belonging to different UEs. In an embodiment, a UE can receive a message from a network node containing a reference signal configuration that has a cyclic shift and comb allocation for a UL reference signal resource. The UE can then transmit the UL-RS based on the UL-RS configuration. Likewise, a network node can send a message to the UE containing a reference signal configuration that has a cyclic shift and comb allocation for a UL reference signal resource. The network node can then receive the UL-RS that was transmitted based on the UL-RS configuration.

### RELATED APPLICATIONS

This application claims the benefit of provisional patent application Ser. No. 63/411,912, filed Sep. 30, 2022, the disclosure of which is hereby incorporated herein by reference in its entirety.

### TECHNICAL FIELD

The present disclosure relates to uplink (UL) reference signal (RS) port mapping for multiple transmission and reception point (multi-TRP) operation in a wireless communication system.

### BACKGROUND

### NR Numerology

In the time domain, New Radio (NR) downlink (DL) and uplink (UL) transmissions are organized into equally sized subframes of 1 ms each. A subframe can further be divided into multiple slots of equal duration. The slot length depends on subcarrier spacing. For 15 kHz subcarrier spacing, there is only one slot per subframe. In general, for 15·2^{μ} kHz subcarrier spacing, where μ∈{0,1,2,3,4}, there are 2^{μ} slots per subframe. Finally, each slot consists of 14 symbols (unless extended cyclic prefix is configured).

In the frequency domain, a system bandwidth is divided into Radio Bearers (RBs) each corresponding to 12 contiguous subcarriers. One subcarrier during one symbol interval forms one RE.

### SRS

In NR, Sounding Reference Signals (SRS) are used for providing channel state information (CSI) to the base station (gNB) in the UL. The usage of SRS includes, e.g., deriving the appropriate transmission/reception beams and/or to perform link adaptation (i.e., setting the transmission rank and the MCS), and for selecting DL (e.g., for PDSCH transmissions) and UL (e.g., for Physical Uplink Shared Channel (PUSCH) transmissions) Multiple Input Multiple Output (MIMO) precoding.

In Long Term Evolution (LTE) and NR, the SRS is configured via Radio Resource Control (RRC), where parts of the configuration can be updated (for reduced latency) through Medium Access Control-Control Element (MAC-CE) signaling. The configuration includes, for example, the SRS resource allocation (the physial mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the gNB in the DL, via the Downlink Control Information (DCI) in the Physical Downlink Control Channel (PDCCH) which instructs the User Equipment device (UE) to transmit the SRS once, at a predetermined time.

When configuring SRS transmissions, the gNB configures, through the SRS-Config IE, a set of SRS resources and a set of SRS resource sets, where each SRS resource set contains one or more SRS resources.

Each SRS resource is configured in RRC see 3GPP TS 38.331 version 16.1.0).

An SRS resource is configurable with respect to, e.g.,
The number of SRS ports (1, 2, or 4), configured by the RRC parameter nrofSRS-Ports.
The transmission comb (i.e., mapping to every 2nd or 4th subcarrier), configured by the RRC parameter transmissionComb, which includes:
   The comb offset, configured by the RRC parameter combOffset, is specified (i.e., which of the combs that should be used).
   The cyclic shift, configured by the RRC parameter cyclicShift, that configures a (port-specific, for multi-port SRS resources) cyclic shift for the Zadoff-Chu sequence that is used for SRS. The use of cyclic shifts increases the number of SRS resources that can be mapped to a comb (as SRS sequences are designed to be (almost) orthogonal under cyclic shifts), but there is a limit on how many cyclic shifts that can be used (8 for comb 2 and 12 for comb 4).
The time-domain position within a given slot, configured with the RRC parameter resourceMapping, which includes:
   The time-domain start position, which is limited to be one of the last 6 symbols (in NR Rel-15) or in any of the 14 symbols in a slot (in NR Rel-16), configured by the RRC parameter startPosition.
   The number of symbols for the SRS resource (that can be set to 1, 2 or 4), configured by the RRC parameter nrofSymbols.
   The repetition factor (that can be set to 1, 2 or 4), configured by the RRC parameter repetitionFactor. When the repetition factor is larger than 1, the same frequency resources are used multiple times across symbols, used to improve the coverage as this allows more energy to be collected by the receiver.
The sounding bandwidth, frequency-domain position and shift, and frequency-hopping pattern of an SRS resource (i.e., which part of the transmission bandwidth that is occupied by the SRS resource) is set through the RRC parameters freqDomainPosition, freqDomainShift, and the freqHopping parameters c-SRS, b-SRS, and b-hop. The smallest possible sounding bandwidth is 4 RBs.
The RRC parameter resourceType determines whether the SRS resource is transmitted as periodic, aperiodic (singe transmission triggered by DCI), or semi persistent (same as periodic except for the start and stop of the periodic transmission is controlled through MAC-CE signaling instead of RRC signaling).
The RRC parameter sequenceId specifies how the SRS sequence is initialized.
The RRC parameter spatialRelationInfo configures the spatial relation for the SRS beam with respect to another reference signal (RS) (which could be another SRS, a synchronization signal block (SSB) or a CSI reference signal (CSI-RS)). If an SRS resource has a spatial relation to another SRS resource, then this SRS resource should be transmitted with the same beam (i.e., virtualization) as the indicated SRS resource.

FIG. 1 illustrates how a Schematic description of how an SRS resource could be allocated in time and frequency within a slot if resourceMapping-r16 is not signaled (note that semi-persistent/periodic SRS resources typically span several slots). In NR Rel-16, the additional (and optional) RRC parameter resourceMapping-r16 was introduced. If resourceMapping-r16 is signaled, the UE shall ignore the RRC parameter resourceMapping. The difference between resourceMapping-r16 and resourceMapping is that the SRS resource (for which the number of OFDM symbols and the repetition factor is still limited to 4) can start in any of the 14 Orthogonal Frequency Division Multiplexing (OFDM) symbols in a slot configured by the RRC parameter startPosition-r16.

An SRS resource set is configured in RRC(See 3GPP TS 38.331 version 16.1.0).

SRS resource(s) will be transmitted as part of an SRS resource set, where all SRS resources in the same SRS resource set can share the same resource type. An SRS resource set is configurable with respect to, e.g.,
For aperiodic SRS, the slot offset is configured by the RRC parameter slotOffset and sets the delay from the PDCCH trigger reception to the start of the SRS transmission.
The resource usage, which is configured by the RRC parameter usage sets constraints and assumptions on the resource properties. SRS resource sets can be configured with one of four different usages: ‘antennaSwitching’, ‘codebook’, ‘nonCodebook’ and ‘beamManagement’.

To summarize, the SRS resource-set configuration determines, e.g., usage, power control, and slot offset for aperiodic SRS. The SRS resource configuration determines the time-and-frequency allocation, the periodicity and offset, the sequence, and the spatial-relation information.

### SRS Coverage

FIG. 2 illustrates SRS transmission without frequency hopping nor repetition in graph 202, with frequency hopping in graph 204, and with repetition in graph 206. Schemes to improve the coverage of SRS have been adopted in NR, including repetition of an SRS resource and/or frequency hopping. The top part of FIG. 2, in graph 202 for reference, depicts an example of SRS transmission without frequency hopping and/or repetition. Here, the entire bandwidth is sounded in a single symbol.

An example of SRS frequency hopping is provided in the middle part of FIG. 2 in graph 204. Here, different parts of the frequency band are sounded in each of four different OFDM symbols, which means that the PSD for SRS will improve (by a factor four compared to the baseline case in the top part of FIG. 2) at the cost of more symbols being used for SRS and a shorter SRS sequence length per OFDM symbol.

An example of SRS repetition is provided in the bottom part of FIG. 2. Here, one SRS resource is transmitted in four consecutive OFDM symbols (by setting the number of SRS symbols per slot and the repetition factor to 4), which will, again, increase the PSD for SRS (by a factor four compared to the baseline case in FIG. 2), again, at the cost of more symbols being used for SRS and decreased SRS (multiplexing) capacity.

It is worth pointing out that SRS repetition and frequency hopping can be used together and, that for semi-persistent and periodic SRS, the frequency-hopping pattern continues beyond the slot boundary (for aperiodic SRS, on the other hand, all parts of the configured bandwidth can be sounded within a slot). To illustrate these two points, FIG. 3 illustrates SRS transmission over two adjacent UL slots using both frequency hopping and repetition. FIG. 3 has a periodic SRS resource (with periodicity one) over two adjacent UL slots. Here, the frequency-hopping configuration is the same as in the middle part of FIG. 2, the repetition factor is 2, and the number of SRS symbols per slot is 4. Note that in this example (and in all the previous examples) all hops (highlighted in blue in the figure(s)) belong to the same SRS resource.

### SRS Capacity

Schemes to improve SRS capacity (i.e., the number of SRS ports that can be multiplexed onto a limited set of time-and-frequency resources) have been adopted in NR, which include using transmission comb 2 or 4 (i.e., sounding only every 2nd or 4th subcarrier within the configured bandwidth), and multiplexing several SRS ports onto the same transmission comb by using different cyclic shifts.

FIG. 4 illustrates how 2 or 4 single-port SRS resources can be multiplexed onto the same configured SRS bandwidth by using transmission comb 2 and 4, respectively. Here, the different SRS resources have been configured with different comb offsets (i.e., RRC-configured with different values of the parameter combOffset).

The SRS base sequences, which are used in NR, are such that they are pairwise orthogonal under cyclic shifts. Utilizing this property, it is possible to multiplex several SRS ports onto the same transmission comb by using different cyclic shifts (and the same base sequence) per SRS port. In NR Rel-16, the maximum number of cyclic shifts is 8 and 12 for transmission comb 2 and 4, respectively. For multi-port SRS resources, the different SRS ports belonging to the same SRS resource will be configured with a port-specific cyclic shift per SRS port. Furthermore, for four-port SRS resources, it is possible to use up to two different transmission combs (with two SRS ports and, hence, two cyclic shifts per comb).

FIG. 5 illustrates a correlation between cyclically shifted SRS base sequences with the corresponding non-shifted base sequence. Here, the sequence length is 48 samples, and the maximum number of cyclic shifts is 8, and CS is short for cyclic shift, in the discrete-time domain (after computing an IDFT), the (amplitude value of the) correlation between a cyclically shifted base sequence and the corresponding non-shifted base sequence. Here, the transmission comb is 2 (such that the maximum number of cyclic shifts is 8) and the sequence length is 48 (which corresponds to an SRS transmission spanning 8 RBs). As shown in FIG. 5, the sequences are orthogonal and, hence, can be separated by means of simple signal processing (e.g., through time-domain windowing).

There are, however, drawbacks with increasing the SRS capacity by using a higher transmission comb and/or using larger number of cyclic shifts. FIG. 6 illustrates a correlation between cyclically shifted SRS base sequences, which have been transmitted over a frequency-selective channel, with the corresponding non-shifted base sequence. Here, the sequence length is 48 samples, and the maximum number of cyclic shifts is 8, and CS is short for cyclic shift. FIG. 6 illustrates an example of how the correlation in FIG. 5 is affected when the SRS is transmitted over a frequency-selective channel, i.e., a channel with a non-zero delay spread (in FIG. 6, the delay spread is 15 samples long). It should be noted that the orthogonality between the SRS sequences is lost due to the frequency-selective channel. Further note that increasing the number of (used) cyclic shift results in more interference (compare the upper and lower part of the figure). Assuming perfect synchronization, the maximum channel delay spread for which there is no interference is inversely proportional to the product of the subcarrier spacing, the transmission comb, and number of (occupied, and uniformly separated) cyclic shifts.

### SRS Sequence and Time-Frequency Mapping

In NR Rel-17, each SRS resource can contain

$${N}_{a p}^{SRS} ∈$$

{1,2,4}SRS ports (in NR Rel-18, up to 8 SRS ports will be supported) in a time-frequency resource with

$${N}_{s y m b}^{SRS} ∈$$

{1,2,4,8,10,12,14} consecutive OFDM symbols in a slot starting from OFDM symbol l₀ a number PRBs starting from subcarrier k₀. An SRS sequence for an SRS antenna port pᵢ at OFDM symbol l′ in an SRS resource is a cyclic shifted version of a Zadoff-Chu sequence \tilde{r}_{u,v}(n) with a group number u∈{0,1, . . . ,29} and a base sequence number ν∈{0,1} within the group, i.e.,

$${r}^{( {p}_{i} )} ( n , {l}^{′} ) = {r}_{u , ν}^{( {α}_{i} , δ )} ( n ) = {e}^{j α n} {\overline{r}}_{u , ν} ( n ) ,$$

$$0 \leq n < {M}_{ZC}$$

$${l}^{′} ∈ \{ 0 , 1 , … , {N}_{symb}^{S R S} - 1 \}$$

### Where:

$${M}_{ZC} = m {N}_{s c}^{R B} / {2}^{δ}$$

is the length of the sequence;
m is the number of RBs configured for the SRS resource;

$${N}_{s c}^{RB} = 12$$

is the number sub-carriers per RB;
δ=log₂(K_{TC}) and K_{TC}∈{2,4,8} is a configured comb value where the SRS sequence; occupies every K_{TC} sub-carriers;

$${α}_{i} = 2 π {n}_{SRS}^{cs , i} / {n}_{SRS}^{cs , max}$$

is a cyclic shift;

$${n}_{SRS}^{cs , m ax}$$

is maximum number of cyclic shifts that can be configured as shown in Table 6.4.1.4.2-1 in 3GPP TS3 8.211 V17.0.0 (see Table 1); and

$${n}_{S R S}^{cs , i} ∈ \{ 0 , 1 , … , {n}_{S R S}^{cs , m ax} - 1 \} .$$

TABLE 1
Maximum number of cyclic shifts as a function of the transmission
comb (reproduced from Table 6.4.1.4.2-1 of 3GPP TS 38.211).

| K_{TC} | ${n}_{SRS}^{cs , m ax}$ |
|---|---|
| 2 | 8 |
| 4 | 12 |
| 8 | 6 |

In case of two SRS ports contained in a SRS resource, the two SRS ports are mapped to the same comb offset but allocated with two different cyclic shifts separated by r. In case of four SRS ports contained in a SRS resource, two possible port-allocation options are supported (unless the transmission comb is 8 (supported since NR Rel-17) for which only the second option is supported). In a first option, the four SRS ports are mapped to the same comb offset but allocated four different cyclic shifts separated by π/2. In a second option, the first two SRS ports are allocated with two different cyclic shifts separated by π on a same set of sub-carriers (with a same first comb offset) and the last two SRS ports are allocated with the same two different cyclic shifts as the first two SRS ports but on a different set of sub-carriers (with a same second comb offset).

The definition of the base sequence r̅_(u,v) (0), . . . , [symbol] r̅_(u,v) (M [symbol] _ZC-1) depends on the sequence length M_ZC and is described in section 5.2.2 of 3GPP TS38.211 V17.0.0.

In NR, the sequence group u is given by

$$u = ( {f}_{g h} ( {n}_{s , f}^{μ} , {l}^{′} ) + {n}_{ID}^{S R S} ) mod 30$$

where

$${n}_{ID}^{SRS} ∈$$

{0, 1, . . . , 1023} is configured by higher layers, and

$${n}_{s , f}^{μ}$$

is the slot number in a radio frame.
Joint DL Transmission from Multiple TRPs

For PDSCH, non-coherent joint transmission (NC-JT) is supported in NR Rel-16. With NC-JT, a subset of the layers of a PDSCH can be transmitted from a first TRP and the rest of layers of the PDSCH can be transmitted from a second TRP.

FIG. 7 illustrates an example of NC-JT where layer 1 of a DSCH is transmitted from TRP1 704 while layer 2 of the PDSCH is transmitted from TRP2 706 to a UE 702. When multiple antenna ports are deployed at each TRP, a precoding matrix would be applied to the PDSCH at each TRP, e.g., w_1 at TRP1 704 and w_2 at TRP2 706. The two TRPs 704 and 706 may be in different physical locations.

In NR Rel-18, coherent joint PDSCH transmission (CJT) from multiple TRPs is to be introduced in which a PDSCH layer can be transmitted from up to four TRPs. An example is shown in FIG. 8, where a same PDSCH layer is transmitted over two TRPs 704 and 706 to UE 702. When multiple antenna ports are deployed at each TRP 704 and 706, a precoding matrix would be applied to the PDSCH at each TRP 704 and 706. In addition, a co-phasing factor 802 is also applied so that the PDSCH from the two TRPs are in phase and thus coherently added at the UE.

There currently exist certain challenge(s). In case of reciprocity-based DL CJT from multiple TRPs, it is important to attain SRS-based channel estimates from multiple different UEs at multiple different TRPs. However, if a same SRS resource is to be received at two TRPs, the difference propagation delay will result in additional interference for, at least, one of the two TRPs. Furthermore, the received power may vary significantly over the two TRPs resulting in additional interference for, at least, one of the two TRPs. In short, cross-SRS interference is a potential issue for TDD CJT.

It is not clear, for the CJT use case, whether a same SRS sequence (TRP-common) will be used by UEs served by a set of TRPs or whether different SRS sequences (TRP-specific) will be used by different sets of UEs. In 3GPP, enhancements to both TRP-common and TRP-specific SRS are being suggested. Next, detailed are some of the issues associated with the first of these two approaches.

FIG. 9 illustrates SRS transmission from two UEs 702 and 902 to two TRPs 704 and 706. In the figure, δ_{x,y} is the propagation delay between UE x and TRP y. Here, UE x is time aligned to and power controlled by TRP x. In the following examples, the transmission comb is K_{TC}=4 (such that there are

$${n}_{SRS}^{CS , m ax} = 12$$

cyclic shifts per comb offset) and the subcarrier spacing is f_{SCS}=60 kHz. Furthermore, wideband SRS transmission is considered over 128 RBs (such that the sequence length is M_{ZC}=12/4·128=384 samples. The carrier frequency is 3.5 GHz. The channel between each UE port and TRP port is a random realization of the TDL-A channel model with an (average) delay spread of 100 ns with free-space path loss (i.e., the path-loss coefficient is 2) and propagation delay Δ_{x,y}=∂_{x,y}/c, where c is the speed of light. The noise level at the TRPs, for simplicity, is assumed to be negligible.

First, consider a 4-port SRS resource being transmitted from UE 1 (UE 2 is not transmitting) for the case δ_{1,1}=50 m and δ_{1,2}=150 m. In this case, the delay difference is Δ_{1,2}=(δ_{1,2}−δ_{1,1})/c≈333 ns. In legacy NR, the separation between cyclic shifts is equidistant and that by configuring cyclicShift to m, for m=0,1, . . . ,5 the 4 ports are mapped to cyclic shifts [0, 3, 6, 9]+m. For m=0, there can be a realization of the received signals at an arbitrary antenna port at TRP 1 and TRP 2. Note that, at TRP 1, the SRS ports are received at the expected delays (i.e., at cyclic shifts [0, 3, 6, 9]). At TRP 2, however, due to the difference in propagation delay, the SRS ports are shifted in the delay domain.

It can be shown that the separation between cyclic shifts is

$${Δ}_{C S} = ( {f}_{SCS} {K}_{TC} {n}_{SRS}^{CS , m ax} ) .$$

In this example, Δ_{CS}=347 ns and, hence, the delay shift due to propagation delay is in the same order as the separation between cyclic shifts which makes it challenging to schedule UEs using a same SRS sequence (TRP-common), especially if the propagation-delay difference is not known to the TRPs (which is typically assumed to be the case). Indeed, if TRP2 where to schedule 4-port UE 2 (for which, in this example, for simplicity, δ_{2,1}=δ_{2,2}=100 m) with cyclic shifts [1,4,7,10], collisions would occur (see FIG. 10). This problem becomes further aggravated when there is more than one UE per TRP, for which delay differences would be different for each UE. In short, delay differences in a CJT scenario reduces SRS capacity.

A multi-port UE can be configured with a multi-port SRS resource with a new cyclic-shift allocation formula that is more suited for multi-TRP operation and introduce dynamic switching between new cyclic-shift allocation and legacy cyclic-shift allocation). However, how to design/configure such a new cyclic-shift allocation scheme is still not been determined and is an open issue.

Certain aspects of the disclosure and their embodiments may provide solutions to these or other challenges.

### SUMMARY

Various embodiments described herein provide for a method and system to adapt UL-RS resource configurations to handle multi-TRP operation for 5G advanced and/or 6G by adapting the cyclic shift separation between UL-RS ports belonging to the same UE and/or adapting the cyclic shift separation between UL-RS ports belonging to different UEs. In an embodiment, a UE can receive a message from a network node containing a reference signal configuration that has a cyclic shift and comb allocation for a UL reference signal resource. The UE can then transmit the UL-RS based on the UL-RS configuration. Likewise, a network node can send a message to the UE containing a reference signal configuration that has a cyclic shift and comb allocation for a UL reference signal resource. The network node can then receive the UL-RS that was transmitted based on the UL-RS configuration.

An embodiment performed by a UE for transmitting UL-RSs to one or more TRPs in a wireless network includes receiving a message from a radio access network node containing a UL-RS configuration, wherein the UL-RS configuration comprises a plurality of cyclic shift values per Sounding Reference Signal resource, and wherein the UL-RS configuration configures one or more UL-RS resources and respective cyclic shifts and/or comb allocations. The method also includes transmitting UL-RS resources based on the UL-RS configuration.

In an embodiment, a UE can be adapted to perform the methods.

In another method, that is performed by a radio access network node for configuring UL-RS resource configurations in a UE to handle multi-TRP operation in a wireless network, the method can include sending a message to the UE containing a UL-RS configuration, wherein the UL-RS configuration comprises a plurality of cyclic shift values per SRS resource, and wherein the UL-RS configuration configures one or more UL-RS resources and respective cyclic shifts and/or comb allocations. The method can also include receiving UL-RS resources from the UE that were transmitted based on the UL-RS configuration.

A radio access network node can be provided that is adapted to perform these methods.

Certain embodiments may provide one or more of the following technical advantage(s). The proposed solution makes UL-RSs (e.g., SRS) more robust towards delay shifts due to differences in propagation delays from a set of UEs to a set of TRPs. This, in turn, will improve channel-estimation quality and DL throughput in a multi-TRP/D-MIMO system (e.g., for CJT).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a schematic diagram of how a SRS resource is allocated in time and frequency according to an embodiment of the present disclosure;

FIG. 2 illustrates SRS transmission according to several embodiments;

FIG. 3 illustrates SRS transmission over two adjacent UL slots according to an embodiment of the present disclosure;

FIG. 4 illustrates single-port SRS resources being multiplexed according to several embodiments of the present disclosure;

FIG. 5 illustrates a correlation between cyclically shifted SRS base sequences with the corresponding non-shifted base sequence according to an embodiment;

FIG. 6 illustrates an example of how the correlation in FIG. 5 is affected when the SRS is transmitted over a frequency-selective channel according to embodiments;

FIG. 7 illustrates an example of NC-JT according to an embodiment;

FIG. 8 illustrates an example of coherent joint transmission according to an embodiment of the present disclosure;

FIG. 9 illustrates SRS transmission from two UEs according to an embodiment of the present disclosure;

FIG. 10 illustrates channel estimation and delay differences for 4-port SRS resources being transmitted from a different UE as received at TRP 1 and 2 according to an embodiment o;

FIG. 11 illustrates a method performed by a UE for transmitting UL-RS to one or more TRPs in a wireless network according to an embodiment of the present disclosure;

FIG. 12 illustrates a method performed by a radio access node for configuring UL-RS resource configurations in a UE to handle Multi-TRP operation in a wireless network according to an embodiment of the present disclosure;

FIG. 13 illustrates multi-TRP operation for an SRS resource with 12 cyclic shifts according to an embodiment of the present disclosure;

FIG. 14 illustrates multi-TRP operation for an SRS resource where UL-RS resource can be configured with cyclic shift ranges according to an embodiment;

FIG. 15 illustrates a case when the cyclic shift separation and cyclic shift range is set such that not all the UL-RS port fits within the cyclic shift range according to an embodiment of the present disclosure;

FIG. 16 shows an example of a communication system 1600 in accordance with some embodiments;

FIG. 17 shows a UE 1700 in accordance with some embodiments; and

FIG. 18 shows a network node 1800 in accordance with some embodiments.

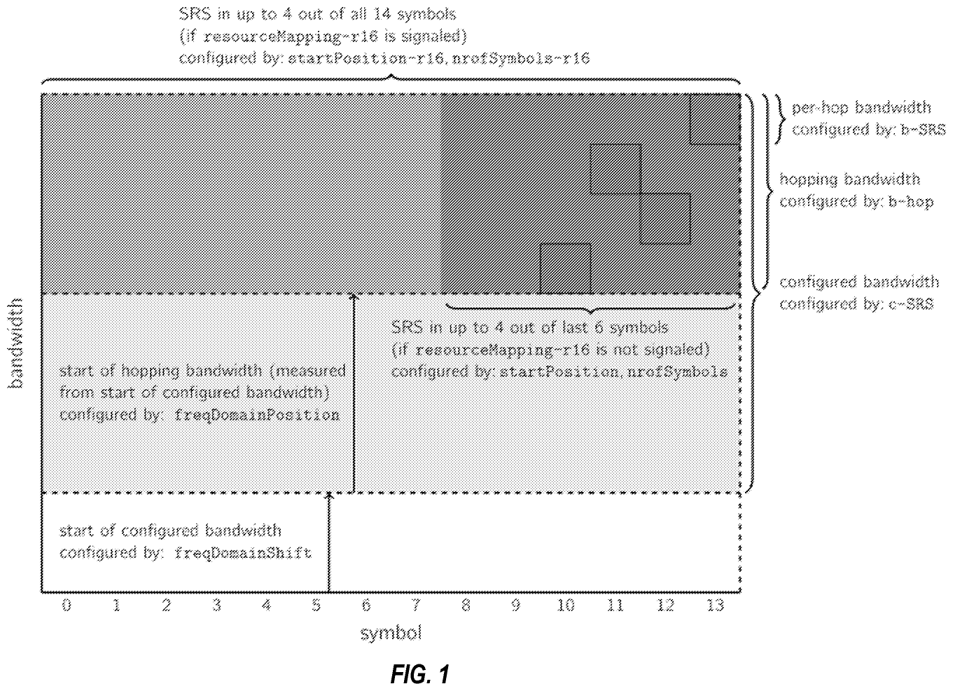

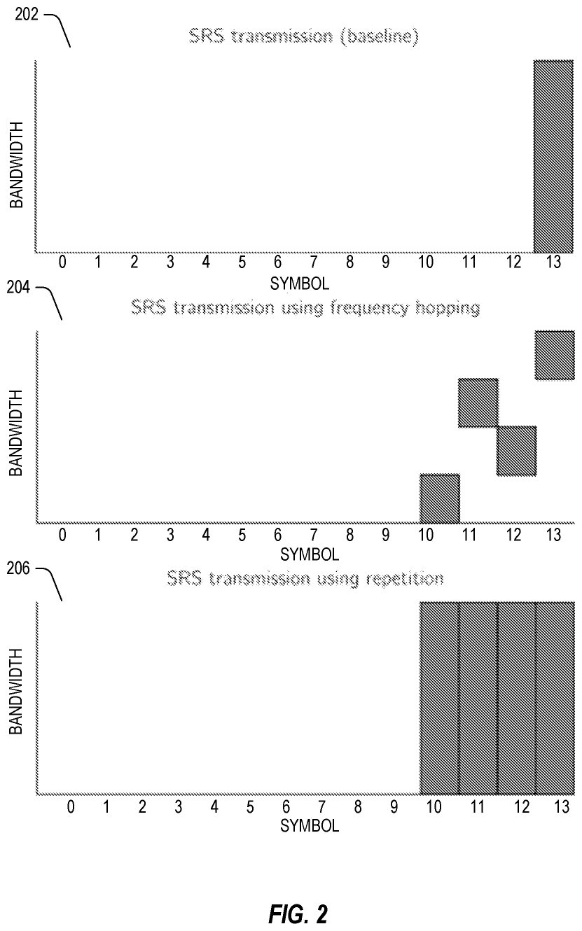

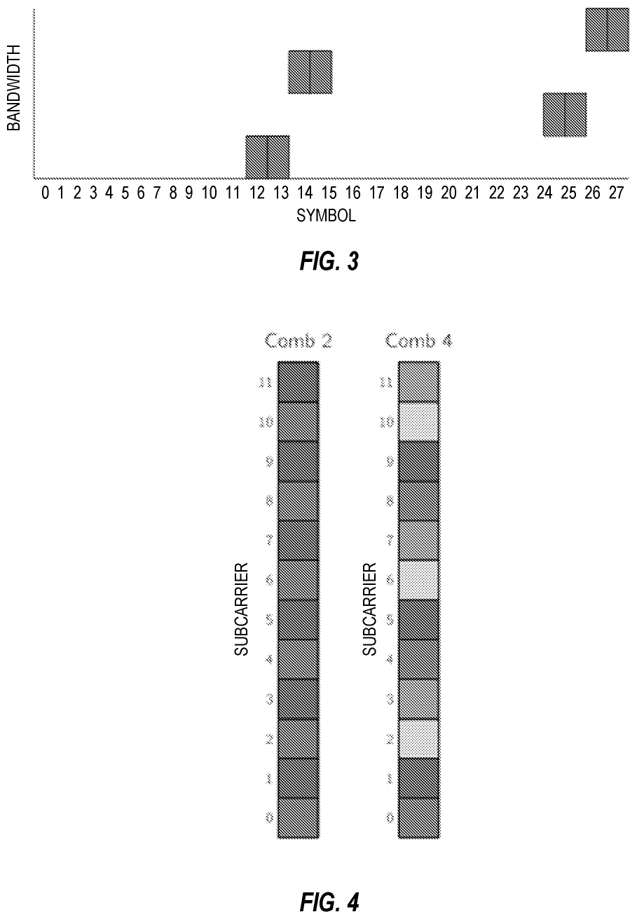

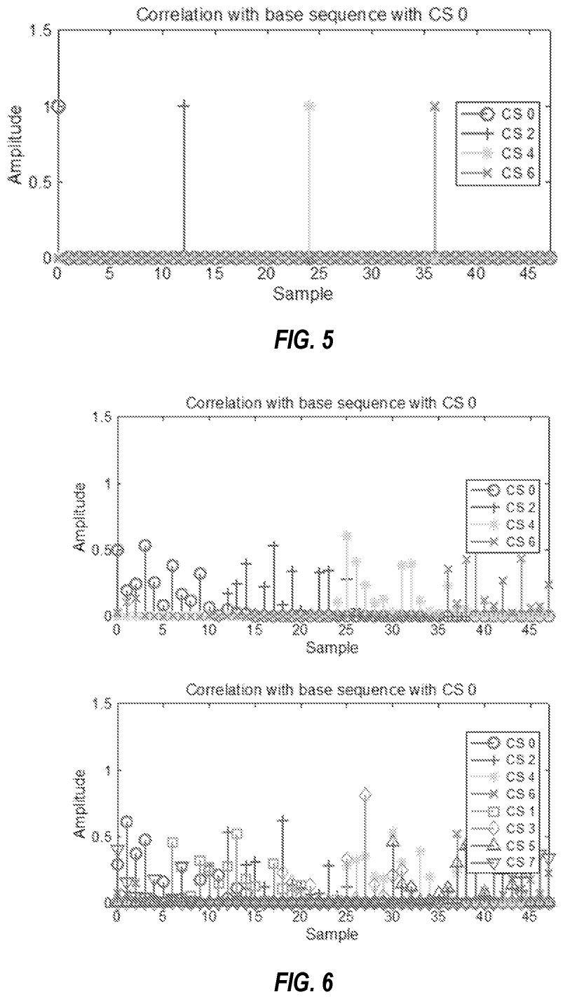

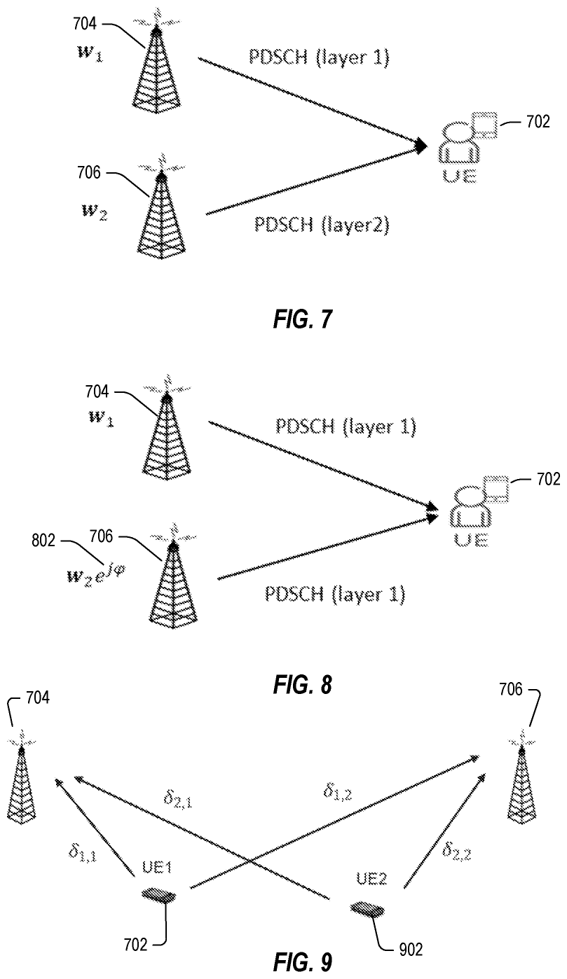

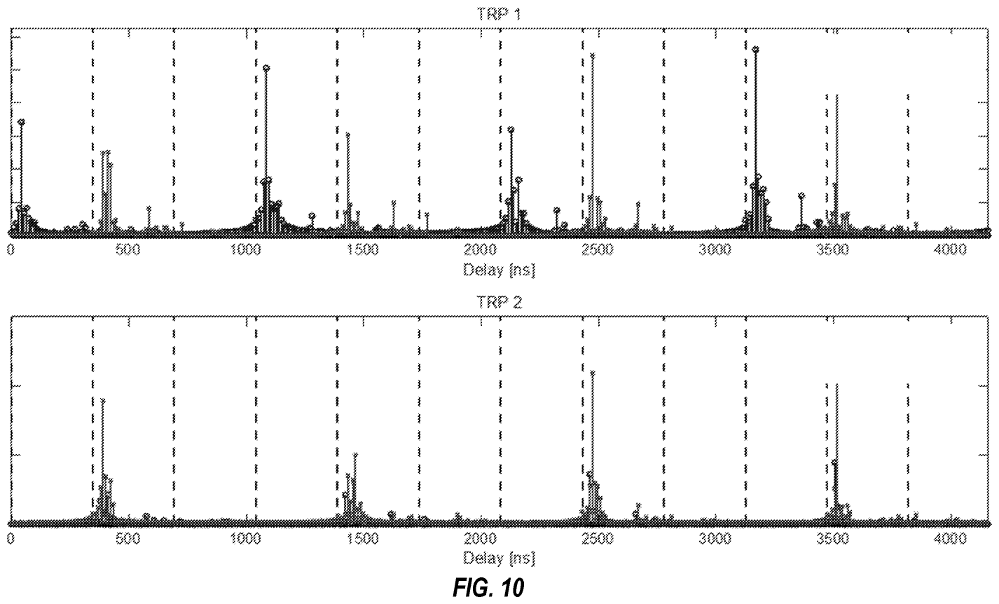

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a UE in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may be a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better PDSCH coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Various embodiments described herein provide for a method and system to adapt uplink reference signal (UL-RS) resource configurations to handle multi-TRP operation for 5G advanced and/or 6G by adapting the cyclic shift separation between UL-RS ports belonging to the same UE and/or adapting the cyclic shift separation between UL-RS ports belonging to different UEs. In an embodiment, a UE can receive a message from a network node containing a reference signal configuration that has a cyclic shift and comb allocation for a UL reference signal resource. The UE can then transmit the UL-RS based on the UL-RS configuration. Likewise, a network node can send a message to the UE containing a reference signal configuration that has a cyclic shift and comb allocation for a UL reference signal resource. The network node can then receive the UL-RS that was transmitted based on the UL-RS configuration.

The disclosure proposes several methods on how to adapt UL-RS resource configurations to handle multi-TRP operation for 5G advanced and/or 6G by adapting the cyclic shift separation between UL-RS ports belonging to the same UE and/or adapting the cyclic shift separation between UL-RS ports belonging to different UEs.

Certain embodiments may provide one or more of the following technical advantage(s). The proposed solution makes UL-RSs (e.g., SRS) more robust towards delay shifts due to differences in propagation delays from a set of UEs to a set of TRPs. This, in turn, will improve channel-estimation quality and DL throughput in a multi-TRP/D-MIMO system (e.g., for CJT).

Some of the embodiments contemplated herein will now be described more fully with reference to the accompanying drawings. Embodiments are provided by way of example to convey the scope of the subject matter to those skilled in the art. Exemplary embodiments of the present disclosure can be described as follows.

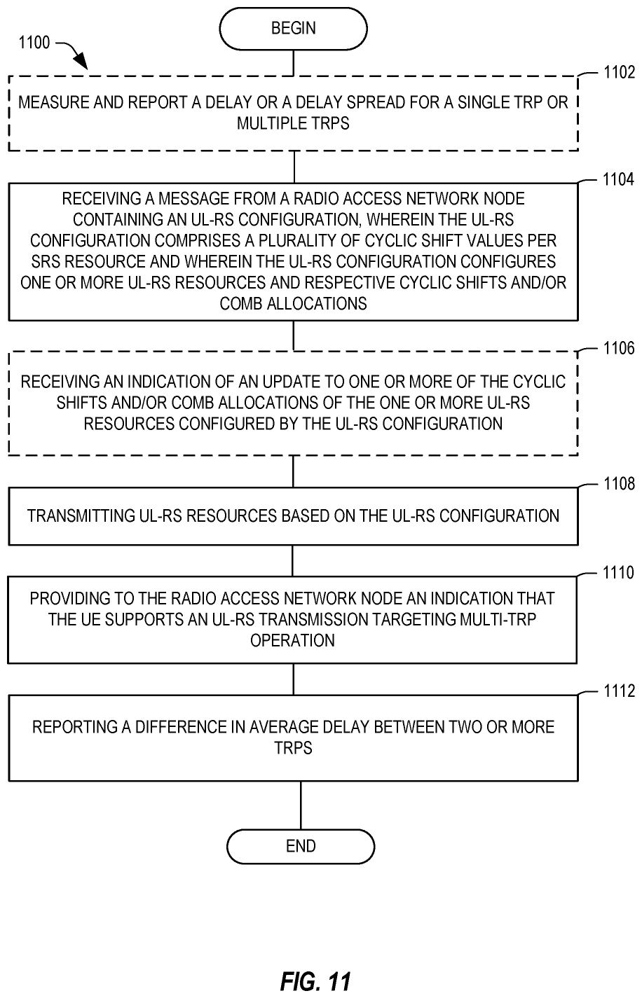

FIG. 11 illustrates a method 1100 performed by a UE, (e.g. 1712) for transmitting uplink reference signals, UL-RS, to one or more TRPs in a wireless network.

The method 1100 can begin with an optional step 1102 where the UE can measure and report (1102) a delay or a delay spread for a single TRP or multiple TRPs. In an embodiment, the measurement can be obtained by performing measurements on an SSB or CSI-RS/TRS from one or multiple TRPs.

At step 1104, the UE can receive a message from a radio access network node containing an UL-RS configuration, wherein the UL-RS configuration comprises a plurality of cyclic shift values per Sounding Reference Signal (SRS) resource, and wherein the UL-RS configuration configures one or more UL-RS resources and respective cyclic shifts and/or comb allocations. In an embodiment, the UL-RS configuration configures all UL-RS ports in one UL-RS resource to adjacent cyclic shifts. In another embodiment, the UL-RS configuration configures a cyclic shift range where the cyclic shift range is configured per UL-RS resource or power UL-RS resource set. In an embodiment, the UL-RS configuration configures a cyclic shift separation wherein the cyclic shift separation is configured per UL-RS resource or power UL-RS resource set. In an embodiment, a first subset of UL-RS ports are allocated to a first comb offset and a second subset of UL-RS ports are allocated to a second comb offset.

At optional step 1106, the method can include receiving an indication of an update to one or more of the cyclic shifts and/or comb allocations of the one or more UL-RS resources configured by the UL-RS configuration.

At step 1108, the method can include transmitting UL-RS resources based on the UL-RS configuration.

At step 1110, the method can include providing to the radio access network node an indication that the UE supports an UL-RS transmission targeting multi-TRP operation. In an embodiment, the indication can indicate at least one of a supported maximum cyclic shift range; supported minimum cyclic shift range; supported maximum cyclic shift separation; supported minimum cyclic shift separation; a supported number of cyclic shift partitions; a support of allocating all UL-RS ports of an UL-RS resource to adjacent cyclic shifts; support of reporting delay spread per TRP; support of reporting average delay difference between different TRPs; support of reporting both delay spread per TRP and average delay between different TRPs in the same report; and a support of dynamically updating one or more of the following parameters using MAC-CE, and/or DCI.

At step 1112, the method can include reporting a difference in average delay between two or more TRPs. In an embodiment, the delay spread and the difference in average delay are reported in a single report.

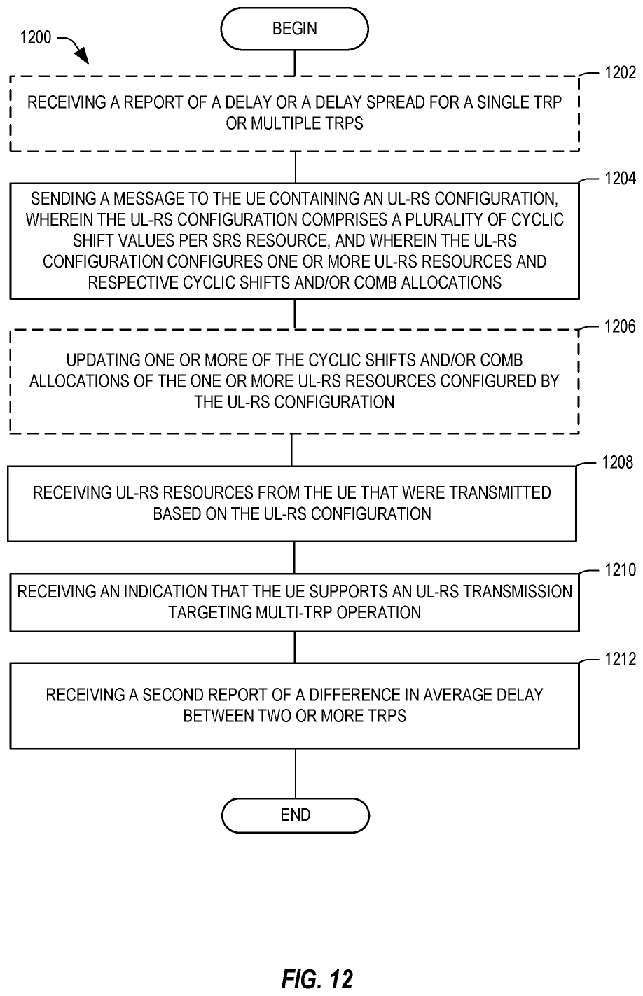

FIG. 12 illustrates a method 1200 performed by a radio access node (e.g., 1610) for configuring UL-RS resource configurations in a UE to handle Multi-TRP operation in a wireless network.

The method 1200 can begin with an optional step 1202 where the radio access network node can receive a report of a delay or a delay spread for a single TRP or multiple TRPs.

At step 1204, the method can include sending a message to the UE containing an UL-RS configuration, wherein the UL-RS configuration comprises a plurality of cyclic shift values per SRS resource, and wherein the UL-RS configuration comprises a plurality of cyclic shift values, and wherein the UL-RS configuration configures one or more UL-RS resources and respective cyclic shifts and/or comb allocations. In an embodiment, the UL-RS configuration configures all UL-RS ports in one UL-RS resource to adjacent cyclic shifts. In another embodiment, the UL-RS configuration configures a cyclic shift range where the cyclic shift range is configured per UL-RS resource or power UL-RS resource set. In an embodiment, the UL-RS configuration configures a cyclic shift separation wherein the cyclic shift separation is configured per UL-RS resource or power UL-RS resource set. In an embodiment, a first subset of UL-RS ports are allocated to a first comb offset and a second subset of UL-RS ports are allocated to a second comb offset.

At optional step 1206, the method can include updating one or more of the cyclic shifts and/or comb allocations of the one or more UL-RS resources configured by the UL-RS configuration.

At step 1208, the method can include receiving UL-RS resources from the UE that were transmitted based on the UL-RS configuration.

At step 1210, the method can include receiving an indication that the UE (1612) supports an UL-RS transmission targeting multi-TRP operation. In an embodiment, the indication can indicate at least one of a supported maximum cyclic shift range; supported minimum cyclic shift range; supported maximum cyclic shift separation; supported minimum cyclic shift separation; a supported number of cyclic shift partitions; a support of allocating all UL-RS ports of an UL-RS resource to adjacent cyclic shifts; support of reporting delay spread per TRP; support of reporting average delay difference between different TRPs; support of reporting both delay spread per TRP and average delay between different TRPs in the same report; and a support of dynamically updating one or more of the following parameters using MAC-CE, and/or DCI

At step 1212, the method can include receiving a second report of a difference in average delay between two or more TRPs. In an embodiment, the first report and the second report are the same report.

Furthermore, in one embodiment, an UL-RS (e.g., SRS) can be configured either for single-TRP or multi-TRP operation.

In one embodiment, a single parameter can be configured (for example using RRC signaling) per UL-RS resource or UL-RS resource set to indicate if the UL-RS resource is targeted to be used for single-TRP operation for multi-TRP operation, and where different cyclic shift (and/or comb) mapping schemes are used for respective case. In one embodiment, when the parameter is indicating single-TRP operation, the corresponding UL-RS resource uses a cyclic shift (and/or comb) mapping that is targeting single-TRP operation (where for example the cyclic shifts of the different UL-RS ports of the UL-RS resource are designed to maximize the robustness against delay spread for the different UL-RS ports). In one embodiment, legacy cyclic shift and/or comb mapping schemes is applied if single-TRP operation is configured.

In one embodiment, when the parameter is indicating multi-TRP operation, the corresponding UL-RS resource uses a cyclic shift (and/or comb) mapping that is targeting multi-TRP operation (where for example the cyclic shifts of the different UL-RS ports of the UL-RS resource are designed to maximize the robustness against delay shift/spread from UL-RS port belonging to another UL-RS resource (e.g., due to difference in propagation delay for UEs that are time aligned with a different TRP). Some examples of how that can be done will be disclosed in the present disclosure.

In one embodiment the parameter determining if a UL-RS resource is designed for single-TRP or multi-TRP operation can be dynamically updated using DCI and/or MAC-CE. This could be useful for example, if the network quickly wants to switch between single-TRP operation and multi-TRP operation for a UE. This could be useful for example if some parts of the UE communication require high reliability (e.g., URLLC) and therefore multi-TRP repetition is required, while some part of the communication can be performed over a single-TRP (e.g., MBB).

In one embodiment for NR, a new parameter is introduced per SRS resource as specified in TS 38.331, where the parameter is used to indicate that a new cyclic shift and/or comb mapping should be used that is targeting multi-TRP operation. When this parameter is “enabled” the UE can use a separate cyclic shift and/or comb mapping than for legacy (NR Rel-15) SRS, where the new cyclic shift mapping and/or comb mapping are targeting multi-TRP operation.

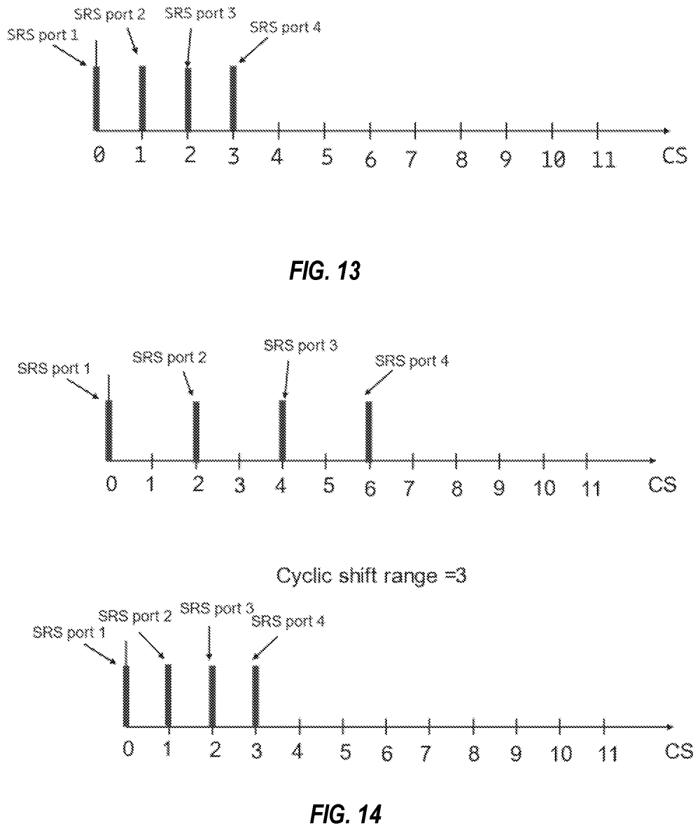

In one embodiment for multi-TRP operation for UL-RS, different UL-RS ports of an UL-RS resource are mapped to cyclic shifts that are adjacent to each other. One example of this embodiment is illustrated in FIG. 13 for an SRS resource with 12 possible cyclic shifts (i.e., an SRS with comb 4) and 4 SRS Ports, with cyclic shift offset set to 0.

In one embodiment an UL-RS resource can be configured with a certain Cyclic shift range, where the Cyclic shift range indicates the distance in cyclic shifts between the first and the last UL-RS port belonging to that UL-RS resource. The UL-RS ports of the UL-RS resource is then uniformly distributed with that range. Two different examples of this are illustrated in, FIG. 114 for Cyclic shift range=7 (upper part) and Cyclic shift range=3 (lower part).

In one embodiment the Cyclic shift range can be configured per SRS resource. In one embodiment, the Cyclic shift range can be dynamically updated using MAC-CE and/or DCI, to for example adapt the SRS transmission depending on if a single-TRP or multi TRP transmission should be used in the network.

In one embodiment, both a Cyclic shift range and another parameter (here referred to as Cyclic shift separation) can be configured per UL-RS resource. The parameter Cyclic shift separation is used to indicate the number of cyclic shifts between two adjacent UL-RS ports of an UL-RS resource. This could be useful in cases where there are issues with large delay spread in the channel towards one TRP (requires large separation between UL-RS ports of the same UL-RS resource, i.e., same UE) and issues with delay differences/spread between TRPs (requires large separation between UL-RS ports of different UL-RS resources, i.e., for different UEs).

In this case, since the number of cyclic shifts is limited, it might not be possible to attain both a large separation between UL-RS ports within an UL-RS resource and between UL-RS ports belonging to different UL-RS resources. Therefore, in one embodiment, in case the Cyclic shift separation and Cyclic shift range is set such that not all the UL-RS port fits within the Cyclic shift range, the UL-RS ports may need to be distributed over more than one comb.

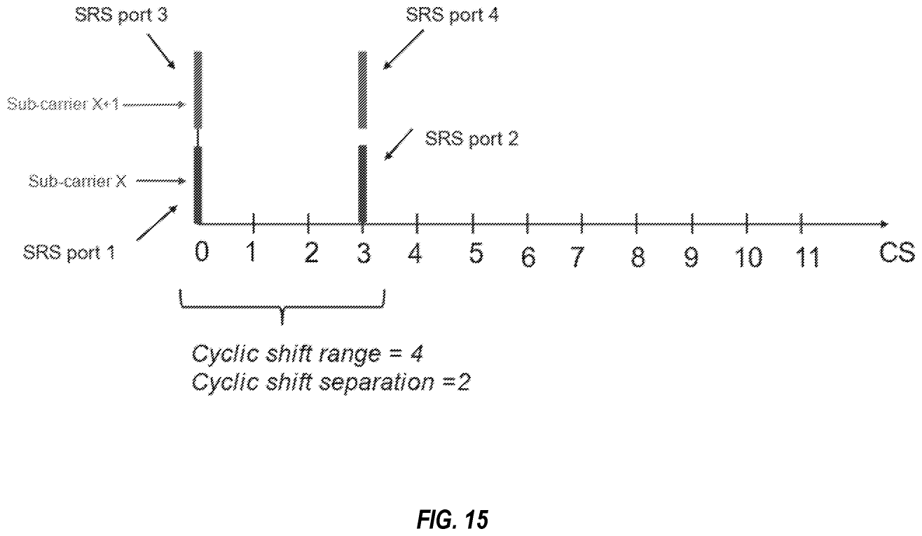

One example of this is illustrated in FIG. 15 for SRS. In this example, comb offset is 0 and 1 (i.e., adjacent sub-carriers are used for the SRS port 0,1 and SRS port 2, 3), which would be the case, e.g., if the configured transmission comb is 2. Note, however, that SRS ports may be mapped to non-adjacent subcarriers (e.g., as can be configured for transmission comb 4 and 8 in legacy NR).

In one embodiment, the number of cyclic shifts/SRS ports, belonging to a same SRS resource, can be implicitly derived from the Cyclic shift range and the Cyclic shift separation.

In one embodiment, the Cyclic shift range and the Cyclic shift separation can be dynamically updated using MAC-CE and/or DCI, to for example adapt the SRS transmission depending on if a single TRP or multi TRP transmission should be used in the network.

In one example of how the two parameters (Cyclic shift range and the Cyclic shift separation) can be introduce in NR per SRS resource.

In one embodiment, the number of cyclic shifts per comb offset will be split between a number of TRPs. In one example of this embodiment, the number of receiving TRPs is known to the UE and the available cyclic shifts will be (implicitly) partitioned according to this number. In an alternate embodiment, the number of partitions is explicitly RRC configured in the SRS resource configuration.

In one embodiment, the number of partitions can be dynamically updated using MAC-CE and/or DCI, to for example adapt the SRS transmission depending on if a single TRP or multi TRP transmission should be used in the network.

In a typical embodiment, each partition spans a number of adjacent cyclic shifts. In another embodiment, each partition spans two or more non-overlapping sets of adjacent cyclic shifts, where there could be non-occupied cyclic shifts between each set.

In one embodiment, it is possible to additionally configure a gap between cyclic-shift partitions to ensure sufficient robustness towards differences in propagation delay towards different TRPs.

The cyclic shifts that are allocated to a UE within a partition will be chosen according to some predetermined rule. In one embodiment, the cyclic shifts/SRS ports that are on a same comb offset will be spaced as far away as possible from each other within a partition. In an alternate embodiment, the cyclic shifts/SRS ports that are on a same comb offset will be placed on adjacent cyclic shifts.

In one embodiment, SRS ports belonging to a same SRS resource may be mapped to partitions on different comb offsets. Note that in NR Rel-18, as agreed in the RAN1 #110 meeting, up to 8 SRS ports will be supported per SRS resource. Furthermore, since NR Rel-17, transmission comb 8, for which there are 6 available cyclic shifts per comb offset, is supported. Hence, it will not be possible to map all 8 ports to a single comb offset for transmission comb 8. In Table 2-4 the possible number of partitions are collected and number of ports per partition per comb offset. Note that only a subset of these partitions and/or mapping may be supported in specification. In one embodiment, the number of partitions are such that all cyclic shifts are included in the partition and such that there is a same number of cyclic shifts in each partition.

TABLE 2
Partitions and possible mappings for transmission comb
2. Number of partitions (number of cyclic shifts per
partition) in italic font implies that not all available
cyclic shifts are included in the partitions.

| | Number of partitions | Number of occupied |
|---|---|---|
| Number of | (max number of cyclic | comb offsets (number of |
| SRS ports | shifts per partition) | ports per comb offset) |
| 1 | 0-1 (8), 2 (4), 3 | 1 (1) |
| 2 | (2), 4 (2), 5-7 | 1 (2), 2 (1) |
| 4 | (1), 8 (1) | 1 (4), 2 (2) |
| 8 | | 1 (8), 2 (4) |

TABLE 3
Partitions and possible mappings for transmission comb
4. Number of partitions (number of cyclic shifts per
partition) in italic font implies that not all available
cyclic shifts are included in the partitions.

| | Number of partitions | Number of occupied |
|---|---|---|
| Number of | (number of cyclic | comb offsets (number of |
| SRS ports | shifts per partition) | ports per comb offset) |
| 1 | 0-1 (12), 2 (6), 3 | 1 (1) |
| 2 | (4), 4 (3), 5 (2), | 1 (2), 2 (1) |
| 4 | 6 (2), 5-11 (1), 12 | 1 (4), 2 (2), 4 (1) |
| 8 | (1) | 1 (8), 2 (4), 4 (2) |

TABLE 4
Partitions and possible mappings for transmission comb
8. Number of partitions (number of cyclic shifts per
partition) in italic font implies that not all available
cyclic shifts are included in the partitions.

| | Number of partitions | Number of occupied |
|---|---|---|
| Number of | (number of cyclic | comb offsets (number of |
| SRS ports | shifts per partition) | ports per comb offset) |
| 1 | 0-1 (6), 2 (3), 3 | 1 (1) |
| 2 | (2), 4-5 (1), 6 | 1 (1), 2 (1) |
| 4 | (1) | 2 (2), 4 (1) |
| 8 | | 4 (2), 8 (1) |

In one embodiment (partition hopping), which partition on a certain comb offset that is associated with a set of SRS ports belonging to a same SRS resource may vary over OFDM symbols according to some predetermined rule/formula.

In one embodiment, a single parameter can be configured (for example using RRC signaling) per UL-RS resource or UL-RS resource set to indicate if the UL-RS resource is targeted to be used for single-TRP operation for multi-TRP operation, and where different cyclic shift (and/or comb) mapping schemes are used for respective case. In one embodiment, when the parameter is indicating single-TRP operation, the corresponding UL-RS resource uses a cyclic shift (and/or comb) mapping that is targeting single-TRP operation (where for example the cyclic shifts of the different UL-RS ports of the UL-RS resource are designed to maximize the robustness against delay spread for the different UL-RS ports). In one embodiment, legacy cyclic shift and/or comb mapping schemes if single-TRP operation is configured.

In one embodiment, when the parameter is indicating multi-TRP operation, the corresponding UL-RS resource uses a cyclic shift (and/or comb) mapping that is targeting multi-TRP operation (where for example the cyclic shifts of the different UL-RS ports of the UL-RS resource are designed to maximize the robustness against delay shift/spread from UL-RS port belonging to another UL-RS resource (e.g., due to difference in propagation delay for UEs that are time aligned with a different TRP). Some examples of how that can be done will be disclosed in the present disclosure.

In one embodiment the parameter determining if a UL-RS resource is designed for single-TRP or multi-TRP operation can be dynamically updated using DCI and/or MAC-CE. This could be useful for example, if the network quickly wants to switch between single-TRP operation and multi-TRP operation for a UE. This could be useful for example if some parts of the UE communication require high reliability (e.g., URLLC) and therefore multi-TRP repetition is required, while some part of the communication can be performed over a single-TRP (e.g., MBB).

In one embodiment for NR, a new parameter is introduced per SRS resource as specified in TS 38.331, where the parameter is used to indicate that a new cyclic shift and/or comb mapping should be used that is targeting multi-TRP operation. One example of how this might look is illustrated in FIG. 13. When this parameter is “enabled” the UE should use a separate cyclic shift and/or comb mapping than for legacy (NR Rel-15) SRS, where the new cyclic shift mapping and/or comb mapping are targeting multi-TRP operation.

In one embodiment for multi-TRP operation for UL-RS, different UL-RS ports of an UL-RS resource are mapped to cyclic shifts that are adjacent to each other. One example of this embodiment is illustrated in FIG. 15 for an SRS resource with 12 possible cyclic shifts (i.e., an SRS with comb 4) and 4 SRS Ports, with cyclic shift offset set to 0.

In one embodiment an UL-RS resource can be configured with a certain Cyclic shift range, where the Cyclic shift range indicates the distance in cyclic shifts between the first and the last UL-RS port belonging to that UL-RS resource. The UL-RS ports of the UL-RS resource is then uniformly distributed with that range. Two different examples of this are illustrated in FIG. 14, for Cyclic shift range=7 (upper part) and Cyclic shift range=3 (lower part).

In one embodiment the Cyclic shift range can be configured per SRS resource as schematically exemplified in FIG. 15. In one embodiment, the Cyclic shift range can be dynamically updated using MAC-CE and/or DCI, to for example adapt the SRS transmission depending on if a single-TRP or multi TRP transmission should be used in the network.

In one embodiment, both a Cyclic shift range and another parameter (here referred to as Cyclic shift separation) can be configured per UL-RS resource. The parameter Cyclic shift separation is used to indicate the number of cyclic shifts between two adjacent UL-RS ports of an UL-RS resource. This could be useful in cases where there are issues with large delay spread in the channel towards one TRP (requires large separation between UL-RS ports of the same UL-RS resource, i.e., same UE) and issues with delay differences/spread between TRPs (requires large separation between UL-RS ports of different UL-RS resources, i.e., for different UEs).

In this case, since the number of cyclic shifts is limited, it might not be possible to attain both a large separation between UL-RS ports within an UL-RS resource and between UL-RS ports belonging to different UL-RS resources. Therefore, in one embodiment, in case the Cyclic shift separation and Cyclic shift range is set such that not all the UL-RS port fits within the Cyclic shift range, the UL-RS ports may need to be distributed over more than one comb.

One example of this is illustrated in FIG. 15 for SRS. In this example, comb offset is 0 and 1 (i.e., adjacent sub-carriers are used for the SRS port 0,1 and SRS port 2, 3), which would be the case, e.g., if the configured transmission comb is 2. Note, however, that SRS ports may be mapped to non-adjacent subcarriers (e.g., as can be configured for transmission comb 4 and 8 in legacy NR).

In one embodiment, the number of cyclic shifts/SRS ports, belonging to a same SRS resource, can be implicitly derived from the Cyclic shift range and the Cyclic shift separation.

In one embodiment, the Cyclic shift range and the Cyclic shift separation can be dynamically updated using MAC-CE and/or DCI, to for example adapt the SRS transmission depending on if a single TRP or multi TRP transmission should be used in the network.

In one example, two parameters (Cyclic shift range and the Cyclic shift separation) can be introduced in NR per SRS resource.

In one embodiment, the number of cyclic shifts per comb offset will be split between a number of TRPs. In one example of this embodiment, the number of receiving TRPs is known to the UE and the available cyclic shifts will be (implicitly) partitioned according to this number. In an alternate embodiment, the number of partitions is explicitly RRC configured in the SRS resource configuration.

In one embodiment, the number of partitions can be dynamically updated using MAC-CE and/or DCI, to for example adapt the SRS transmission depending on if a single TRP or multi TRP transmission should be used in the network.

In a typical embodiment, each partition spans a number of adjacent cyclic shifts. In another embodiment, each partition spans two or more non-overlapping sets of adjacent cyclic shifts, where there could be non-occupied cyclic shifts between each set.

In one embodiment, it is possible to additionally configure a gap between cyclic-shift partitions to ensure sufficient robustness towards differences in propagation delay towards different TRPs.

The cyclic shifts that are allocated to a UE within a partition will be chosen according to some predetermined rule. In one embodiment, the cyclic shifts/SRS ports that are on a same comb offset will be spaced as far away as possible from each other within a partition. In an alternate embodiment, the cyclic shifts/SRS ports that are on a same comb offset will be placed on adjacent cyclic shifts.

In one embodiment, SRS ports belonging to a same SRS resource may be mapped to partitions on different comb offsets. Note that in NR Rel-18, as agreed in the RAN1 #110 meeting, up to 8 SRS ports will be supported per SRS resource. Furthermore, since NR Rel-17, transmission comb 8, for which there are 6 available cyclic shifts per comb offset, is supported. Hence, it will not be possible to map all 8 ports to a single comb offset for transmission comb 8. In Table 5-7 the possible number of partitions are collected and number of ports per partition per comb offset. Note that only a subset of these partitions and/or mapping may be supported in specification. In one embodiment, the number of partitions are such that all cyclic shifts are included in the partition and such that there is a same number of cyclic shifts in each partition.

TABLE 5
Partitions and possible mappings for transmission comb
2. Number of partitions (number of cyclic shifts per
partition) in italic font implies that not all available
cyclic shifts are included in the partitions.

| | Number of partitions | Number of occupied |
|---|---|---|
| Number of | (max number of cyclic | comb offsets (number of |
| SRS ports | shifts per partition) | ports per comb offset) |
| 1 | 0-1 (8), 2 (4), 3 | 1 (1) |
| 2 | (2), 4 (2), 5-7 | 1 (2), 2 (1) |
| 4 | (1), 8 (1) | 1 (4), 2 (2) |
| 8 | | 1 (8), 2 (4) |

TABLE 6
Partitions and possible mappings for transmission comb
4. Number of partitions (number of cyclic shifts per
partition) in italic font implies that not all available
cyclic shifts are included in the partitions.

| | Number of partitions | Number of occupied |
|---|---|---|
| Number of | (number of cyclic | comb offsets (number of |
| SRS ports | shifts per partition) | ports per comb offset) |
| 1 | 0-1 (12), 2 (6), 3 | 1 (1) |
| 2 | (4), 4 (3), 5 (2), | 1 (2), 2 (1) |
| 4 | 6 (2), 5-11 (1), 12 | 1 (4), 2 (2), 4 (1) |
| 8 | (1) | 1 (8), 2 (4), 4 (2) |

TABLE 7
Partitions and possible mappings for transmission comb
8. Number of partitions (number of cyclic shifts per
partition) in italic font implies that not all available
cyclic shifts are included in the partitions.

| | Number of partitions | Number of occupied |
|---|---|---|
| Number of | (number of cyclic | comb offsets (number of |
| SRS ports | shifts per partition) | ports per comb offset) |
| 1 | 0-1 (6), 2 (3), 3 | 1 (1) |
| 2 | (2), 4-5 (1), 6 | 1 (1), 2 (1) |
| 4 | (1) | 2 (2), 4 (1) |
| 8 | | 4 (2), 8 (1) |

In one embodiment (partition hopping), which partition on a certain comb offset that is associated with a set of SRS ports belonging to a same SRS resource may vary over OFDM symbols according to some predetermined rule/formula.

In one embodiment, a list containing a combination of parameters may be configured by higher layers (e.g., via RRC signaling). Each element of the list contains different values for a combination of one or more of the following parameters: (1) cyclic shift value, (2) cyclic shift range, (3) cyclic shift separation, and (4) number of partitions. Each element of the list is then mapped to a codepoint of a field in DCI. In some embodiments, when an SRS resource is triggered by a DCI (e.g., aperiodic SRS triggering), the triggering DCI contains the field which indicates one codepoint mapped to one of the elements from the list. The UE uses parameter combination corresponding to the one of the elements for SRS transmission. This embodiment involves a combination of RRC signaling (e.g., configuration of the list where each element contains different values for a combination of one or more of the above parameters), and DCI signaling (e.g., indicating one of the elements from the list via DCI).

Although the previous DCI related embodiment is described from the perspective of a triggered SRS (e.g., aperiodic SRS), the embodiment may also be applied to periodic SRS or semi-persistent SRS as well. For instance, for periodic/semi-persistent SRS, when a DCI indicates in slot n an element indicating values for one or more of the parameter combinations, the UE applies the indicated parameter combination values for periodic/semi-persistent SRS transmission in SRS transmission occasions starting from slot n+Tₛ. In some embodiments, when there are multiple SRS resources or SRS resource sets configured, the DCI also may indicate to which SRS resource(s) or SRS resource set(s) the indicated parameter combination values applies to.

In another embodiment, a field in a MAC CE indicates an identifier to one of the elements in the list. In some embodiments, when an SRS resource is activated by a MAC CE (e.g., semi-persistent SRS activation), the activating MAC CE contains the field which indicates an identifier mapped to one of the elements from the list. The UE uses parameter combination corresponding to the indicated identifier for SRS transmission. This embodiment involves a combination of RRC signaling (e.g., configuration of the list where each element contains different values for a combination of one or more of the above parameters), and MAC CE signaling (e.g., indicating one of the elements from the list via MAC CE).

Although the previous MAC CE related embodiment is described from the perspective of an activated SRS (e.g., semi-persistent SRS), the embodiment may also be applied to periodic SRS as well. For instance, for periodic SRS, when a MAC CE indicates in slot n an element indicating values for one or more of the parameter combinations, the UE applies the indicated parameter combination values for periodic SRS transmission in SRS transmission occasions starting from slot n+Tₛ. In some embodiments, when there are multiple SRS resources or SRS resource sets configured, the MAC CE also may indicate to which SRS resource(s) or SRS resource set(s) the indicated parameter combination values applies to.

In yet another embodiment, the MAC CE contains individual fields for each one or more of the following parameters: (1) cyclic shift value, (2) cyclic shift range, (3) cyclic shift separation, and (4) number of partitions. When an activating MAC CE (e.g., in the case a semi-persistent SRS is activated), the UE uses the parameter values indicated in the respective individual fields for SRS transmission. In some embodiments, when there are multiple SRS resources or SRS resource sets configured, the MAC CE also may indicate to which SRS resource(s) or SRS resource set(s) the indicated parameter values apply to.

In one embodiment, the UE can be triggered to report the delay between a set of TRPs (for example on a set of SSBs or a set of CSI-RS/TRS transmitted from multiple different TRPs). In one embodiment, the UE can be triggered to report the delay spread associated per TRP (e.g., by performing measurements on an SSB or CSI-RS/TRS from one TRP). Based on this information, the network can determine suitable cyclic shift separation between UL-RS ports belonging to the same UL-RS resource (i.e., the same UE) and/or suitable cyclic shift separation between UL-RS ports belonging to different UL-RS resource (i.e., between different UEs).

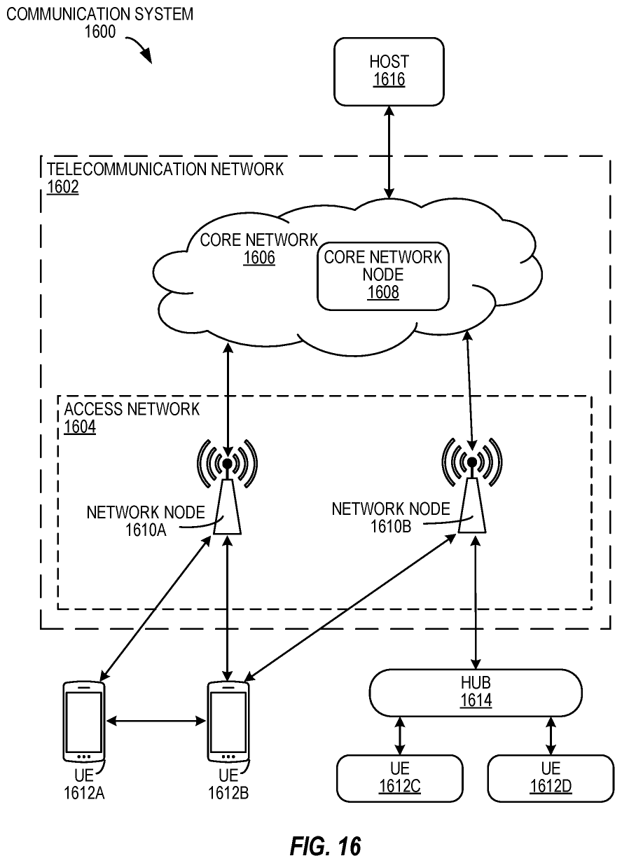

FIG. 16 shows an example of a communication system 1600 in accordance with some embodiments.

In the example, the communication system 1600 includes a telecommunication network 1602 that includes an access network 1604, such as a Radio Access Network (RAN), and a core network 1606, which includes one or more core network nodes 1608. The access network 1604 includes one or more access network nodes, such as network nodes 1610A and 1610B (one or more of which may be generally referred to as network nodes 1610), or any other similar 3GPP access node or non-3GPP Access Point (AP). The network nodes 1610 facilitate direct or indirect connection of User Equipment (UE), such as by connecting UEs 1612A, 1612B, 1612C, and 1612D (one or more of which may be generally referred to as UEs 1612) to the core network 1606 over one or more wireless connections.

In an embodiment, UE 1612 and network nodes 1610 can perform the functionality described in the methods described in FIGS. 11 and 12 respectively, in configuring the UL-RS resource configurations of the UE 1612 to handle multi-TRP operation for 5G advanced and/or 6G by adapting the cyclic shift separation between UL-RS ports belonging to the same UE and/or adapting the cyclic shift separation between UL-RS ports belonging to different UEs. For example, the network nodes 1610 can configure the UL-RS resource configurations as described in FIG. 12 by providing a message to the UE 1612 containing the UL-RS configuration and receive UL-RS resources from the UE 1612 that were transmitted based on the UL-RS configuration. Likewise, the UE 1612 can transmit UL-RS to one more TRPs (e.g., network nodes 1610) and receive a message from a radio access network node 1610 containing an UL-RS configuration and perform the other steps described in FIG. 11.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Some examples of core network nodes have been described earlier.

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system 1600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1602 is a cellular network that implements 3GPP standardized features. Accordingly, the telecommunication network 1602 may support network slicing to provide different logical networks to different devices that are connected to the telecommunication network 1602. For example, the telecommunication network 1602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-Radio Access Technology (RAT) or multi-standard mode. For example, a UE may operate with any one or combination of WiFi, NR, and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1614 communicates with the access network 1604 to facilitate indirect communication between one or more UEs (e.g., UE 1612C and/or 1612D) and network nodes (e.g., network node 1610B). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a Virtual Reality (VR) headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610B. The hub 1614 may also allow for a different communication scheme and/or schedule between the hub 1614 and UEs (e.g., UE 1612C and/or 1612D), and between the hub 1614 and the core network 1606. In other examples, the hub 1614 is connected to the core network 1606 and/or one or more UEs via a wired connection. Moreover, the hub 1614 may be configured to connect to a Machine-to-Machine (M2M) service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610B. In other embodiments, the hub 1614 may be a non-dedicated hub—that is, a device which is capable of operating to route communications between the UEs and the network node 1610B, but which is additionally capable of operating as a communication start and/or end point for certain data channels.

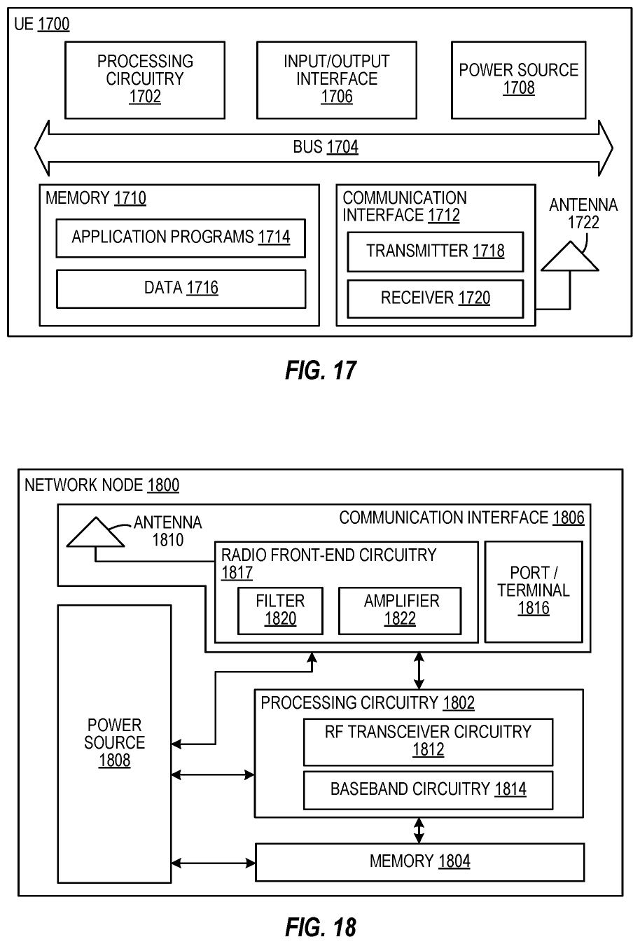

FIG. 17 shows a UE 1700 in accordance with some embodiments. The UE 1700 can be the UE 1610 described in FIG. 16, and by the UE that performs the method described in FIG. 11. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1702 may include multiple Central Processing Units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging the power source 1708. Power circuitry may perform any formatting, converting, or other modification to the power from the power source 1708 to make the power suitable for the respective components of the UE 1700 to which power is supplied.

The memory 1710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1710 may allow the UE 1700 to access instructions, application programs, and the like stored on transitory or non-transitory memory media, to off-load data, or to upload data. An article of manufacture, such as one utilizing a communication system, may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., the antenna 1722) and may share circuit components, software, or firmware, or alternatively be implemented separately.

In the illustrated embodiment, communication functions of the communication interface 1712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, etc. AUE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 18 shows a network node 1800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, eNBs, and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes processing circuitry 1802, memory 1804, a communication interface 1806, and a power source 1808. The network node 1800 may be composed of multiple physically separate components (e.g., a Node B component and an RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1800 may be configured to support multiple RATs. In such embodiments, some components may be duplicated (e.g., separate memory 1804 for different RATs) and some components may be reused (e.g., an antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1800.

The processing circuitry 1802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1800 components, such as the memory 1804, to provide network node 1800 functionality.

In some embodiments, the processing circuitry 1802 includes a System on a Chip (SOC). In some embodiments, the processing circuitry 1802 includes one or more of Radio Frequency (RF) transceiver circuitry 1812 and baseband processing circuitry 1814. In some embodiments, the RF transceiver circuitry 1812 and the baseband processing circuitry 1814 may be on separate chips (or sets of chips), boards, or units, such as radio units and digital units. In alternative embodiments, part or all of the RF transceiver circuitry 1812 and the baseband processing circuitry 1814 may be on the same chip or set of chips, boards, or units.

The memory 1804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and the memory 1804 are integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. The radio front-end circuitry 1818 comprises filters 1820 and amplifiers 1822. The radio front-end circuitry 1818 may be connected to the antenna 1810 and the processing circuitry 1802. The radio front-end circuitry 1818 may be configured to condition signals communicated between the antenna 1810 and the processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of the filters 1820 and/or the amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface 1806 may comprise different components and/or different combinations of components.

In certain alternative embodiments, the network node 1800 does not include separate radio front-end circuitry 1818; instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes the one or more ports or terminals 1816, the radio front-end circuitry 1818, and the RF transceiver circuitry 1812 as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, the communication interface 1806, and/or the processing circuitry 1802 may be configured to perform any receiving operations and/or certain obtaining operations described herein as being performed by the network node 1800. Any information, data, and/or signals may be received from a UE, another network node, and/or any other network equipment. Similarly, the antenna 1810, the communication interface 1806, and/or the processing circuitry 1802 may be configured to perform any transmitting operations described herein as being performed by the network node 1800. Any information, data, and/or signals may be transmitted to a UE, another network node, and/or any other network equipment.

The power source 1808 provides power to the various components of the network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid or an electricity outlet) via input circuitry or an interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

1. A method performed by a User Equipment device (UE) for transmitting uplink reference signals (UL-RSs) to one or more Transmission Reception Points (TRPs) in a wireless network, the method comprising:
receiving a message from a radio access network node containing a UL-RS configuration, wherein the UL-RS configuration comprises a plurality of cyclic shift values per Sounding Reference Signal (SRS) resource, and wherein the UL-RS configuration configures one or more UL-RS resources and respective cyclic shifts and/or comb allocations; and
transmitting UL-RS resources based on the UL-RS configuration.

2. The method of claim 1, further comprising:
measuring and reporting a delay or a delay spread for a single TRP or multiple TRPs.

3. The method of claim 2, wherein the delay for multiple TRPs is based on a set of Synchronization Signal Blocks (SSBs) or a set of Channel State Information Reference Signals (CSI-RSs) transmitted from the multiple TRPs and the delay spread associated per TRP for the multiple TRPs is based on measurements performed on an SSB or CSI-RS from a TRP.

4. The method of claim 1, further comprising:
receiving an indication of an update to one or more of the cyclic shifts and/or comb allocations of the one or more UL-RS resources configured by the UL-RS configuration.

5. The method of claim 1, further comprising:
providing to the radio access network node an indication that the UE supports a UL-RS transmission targeting multi-TRP operation.

6. The method of claim 5, wherein the indication that the UE supports the UL-RS transmission targeting multi-TRP operation indicates at least one of:
a. a supported maximum cyclic shift range;
b. a supported minimum cyclic shift range;
c. a supported maximum cyclic shift separation;
d. a supported minimum cyclic shift separation;
e. a supported number of cyclic shift partitions;
f. a support of allocating all UL-RS ports of a UL-RS resource to adjacent cyclic shifts;
g. a support of reporting delay spread per TRP;
h. a support of reporting average delay difference between different TRPs;
i. a support of reporting both delay spread per TRP and average delay between different TRPs in the same report; and
j. a support of dynamically updating one or more parameters using a Medium Access Control Control Element (MAC-CE) and/or Downlink Control Information (DCI).

7. (canceled)

8. The method of claim 1, wherein the UL-RS configuration configures a cyclic shift range or a cycle shift separation.

9. The method of claim 8, wherein the cyclic shift range or the cyclic shift separation is configured per UL-RS resource or per UL-RS resource set.

10.-12. (canceled)

13. The method of claim 2, further comprising:
based on the delay or the delay spread for the single TRP or multiple TRPs, determining at least one of a cyclic shift separation between UL-RS ports of a UL-RS resource or cyclic shift separation between UL-RS ports belonging to different UL-RS resources.

14. The method of claim 1, wherein a cyclic shift per SRS transmission varies over the plurality of cyclic shift values.

15. A User Equipment device (UE) for transmitting uplink reference signals (UL-RSs) to one or more Transmission Reception Points (TRPs) in a wireless network, the UE adapted to:
receive a message from a radio access network node containing a UL-RS configuration, wherein the UL-RS configuration comprises a plurality of cyclic shift values per Sounding Reference Signal (SRS) resource, and wherein the UL-RS configuration configures one or more UL-RS resources and respective cyclic shifts and/or comb allocations; and
transmit UL-RS resources based on the UL-RS configuration.

16. A method performed by a radio access network node for configuring uplink reference signals (UL-RS) resource configurations in a User Equipment device (UE) to handle Multiple Transmission Reception Point (Multi-TRP) operation in a wireless network, the method comprising:
sending a message to the UE containing a UL-RS configuration, wherein the UL-RS configuration comprises a plurality of cyclic shift values per Sounding Reference Signal (SRS) resource, and wherein the UL-RS configuration configures one or more UL-RS resources and respective cyclic shifts and/or comb allocations; and
receiving UL-RS resources from the UE that were transmitted based on the UL-RS configuration.

17. The method of claim 16, further comprising:
receiving a report of a delay or a delay spread for a single TRP or multiple TRPs.

18. The method of claim 17, wherein the delay for multiple TRPs is based on a set of Synchronization Signal Blocks (SSBs) or a set of Channel State Information Reference Signals (CSI-RSs) transmitted from the multiple TRPs and the delay spread associated per TRP for the multiple TRPs is based on measurements performed on an SSB or CSI-RS from a TRP.

19. The method of claim 17, further comprising:
based on the delay or the delay spread for the single TRP or multiple TRPs, determining at least one of a cyclic shift separation between UL-RS ports of a UL-RS resource or cyclic shift separation between UL-RS ports belonging to different UL-RS resources.

20. The method of claim 16, further comprising:
updating one or more of the cyclic shifts and/or comb allocations of the one or more UL-RS resources configured by the UL-RS configuration.

21. The method of claim 16, further comprising:
receiving an indication that the UE supports a UL-RS transmission targeting Multi-TRP operation;
wherein the indication indicates at least one of:
a. a supported maximum cyclic shift range;
b. a supported minimum cyclic shift range;
c. a supported maximum cyclic shift separation;
d. a supported minimum cyclic shift separation;
e. a supported number of cyclic shift partitions;
f. a support of allocating all UL-RS ports of a UL-RS resource to adjacent cyclic shifts;
g. a support of reporting delay spread per TRP;
h. a support of reporting average delay difference between different TRPs;
i. a support of reporting both delay spread per TRP and average delay between different TRPs in the same report; and
j. a support of dynamically updating one or more parameters using Medium Access Control-Control Element, MAC-CE, and/or Downlink Control Information, DCI.

22.-23. (canceled)

24. The method of claim 16, wherein the UL-RS configuration configures a cyclic shift range or a cyclic shift separation.

25. The method of claim 24, wherein the cyclic shift range or the cyclic shift separation is configured per UL-RS resource or per UL-RS resource set.

26.-28. (canceled)

29. The method of claim 16, further comprising:
receiving a first report of a delay spread associated with a TRP; or
a second report of a difference in average delay between two or more TRPs.

30.-32. (canceled)
